(19) United States
(12) Patent Application Publication
(10) Pub. No.: US 2007/0245539 A1
(43) Pub. Date: Oct. 25, 2007

(54) METHOD AND APPARATUS FOR HOT RIVETING

(76) Inventor: Richard Tillberg, Widewater (CA)

Correspondence Address: DAVIS & BUJOLD, P.L.L.C., 112 PLEASANT STREET, CONCORD, NH, 03301, US

(21) Appl. No.: 11/737,195

(22) Filed: Apr. 19, 2007

Related U.S. Application Data
(60) Provisional application No. 60/793,092, filed on Apr. 19, 2006.

(51) Int. Cl. B23P 11/02

(52) U.S. Cl. 29/524.1; 29/447; 29/525.05; 29/525.06

(57) ABSTRACT

A method of hot riveting is described. A first step involves using a clamp to exert a clamping force upon a head of a rivet to maintain the rivet in a selected opening of a workpiece. A second step involves heating an opposed end of the rivet in preparation for shaping. A third step involves deforming the opposed end of the rivet to a desired shape with a hammer.

### FIELD OF THE INVENTION

The present invention relates to a method of hot riveting and, in particular, hot riveting endless tracks of tracked vehicles.

### BACKGROUND OF THE INVENTION

Hot riveting is widely used as the preferred method of securing together links of endless tracks used on tracked vehicles. Hot riveting has traditionally been a two person job.

### SUMMARY OF THE INVENTION

According to the present invention there is provided a method of hot riveting. A first step involves using a clamp to exert a clamping force upon a head of a rivet to maintain the rivet in a selected opening of a workpiece. A second step involves heating an opposed end of the rivet in preparation for shaping. A third step involves deforming the opposed end of the rivet to a desired shape with a hammer.

According to another aspect of the present invention there is provided a clamp that can be used when performing this method of hot riveting.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective view showing a first step of the method in accordance with the teaching of the present invention.

FIG. 2 is a perspective view showing a second step of the method in accordance with the teaching of the present invention.

FIG. 3 is a perspective view showing a third step of the method in accordance with the teaching of the present invention.

### DETAILED DESCRIPTION OF THE PREFERRED EMBODIMENT

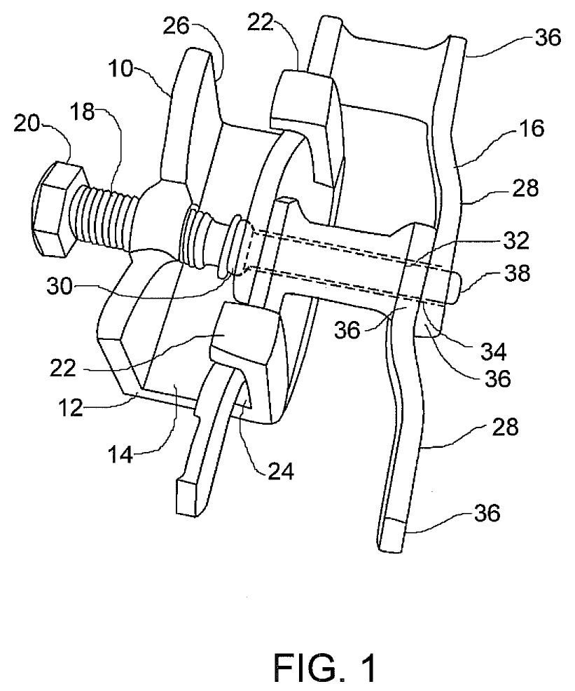

The preferred embodiment, an apparatus for hot riveting is in the form of a clamp generally identified by reference numeral 10, will now be described with reference to FIG. 1 through 3.

Structure and Relationship of Parts:

Referring to FIG. 1, clamp 10 has a body 12 defining a channel 14 to accommodate a portion of an endless track 16. A rotatable pressure screw 18 is mounted on body 12 which, when rotated in a first rotational direction, moves in a first axial direction further into channel 14. When screw 18 is rotated in a second rotation direction, it moves in a second axial direction and withdraws from channel 14. This allows track 16 to be clamped and removed. A wrench engaging screw head 20 is on pressure screw 18 and is used to rotate pressure screw 18 to exert the clamping force. Hooks 22 are integrally formed with body 12 along a first side 24 of channel 14, opposed to pressure screw 18 and pointing toward a second side 26 of channel 14. Hooks 22 are adapted for insertion into adjoining sections 28 of endless track 16.

Operation:

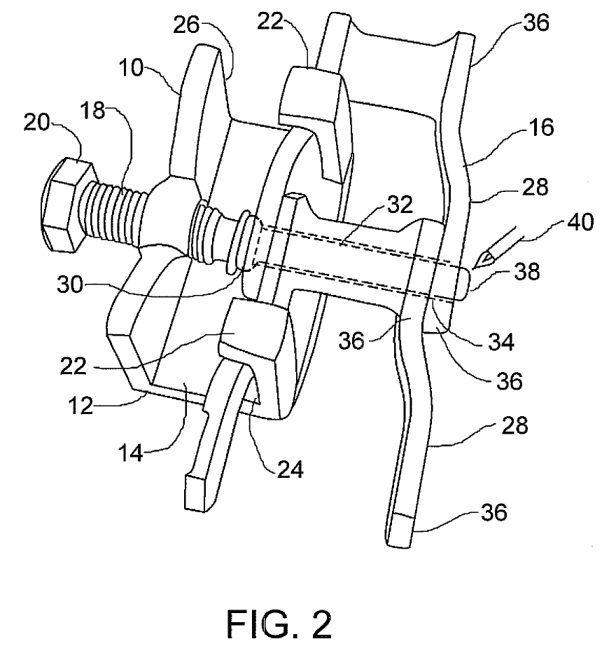

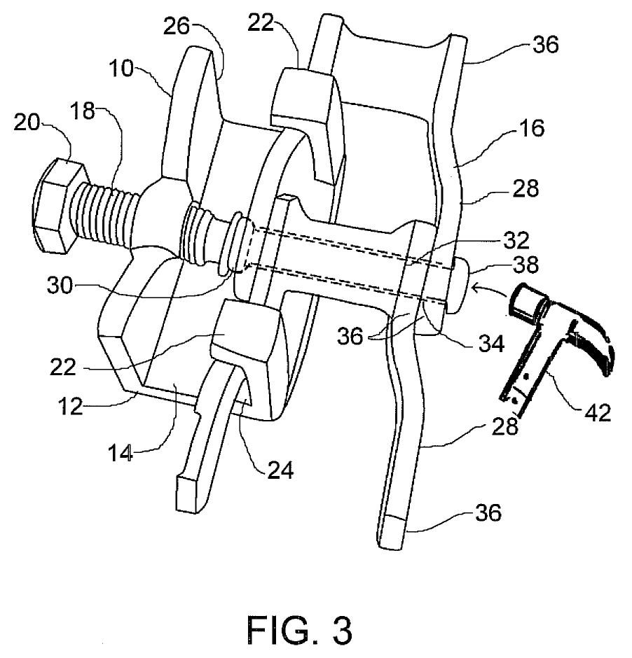

Referring now to FIG. 1, clamp 10 is provided as discussed above. The first step involves using clamp 10 to exert a clamping force upon a head 30 of a rivet 32 to maintain rivet 32 in a selected opening 34 of endless track 16 that belongs to a tracked vehicle. Opening 34 is provided by connectors 36 between two adjoining sections 28 of track 16. Once rivet 32 is positioned in opening 34, track 16 is clamped by first inserting it into channel 14 of body 12 with hooks 22 inserted into openings of sections 28. Then, pressure screw 18 is rotated by means of wrench engaging screw head 20 in the first rotational direction to move pressure screw 18 further into channel 14 to exert the clamping force to head 30 of rivet 32. Referring to FIG. 2, end 38 (opposite head 30) of rivet 32 is heated in preparation for shaping by a heat source 40. Referring to FIG. 3, end 38 is then deformed to a desired shape with a hammer 42.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

What is claimed is:

1. A method of hot riveting, comprising the steps of:
using a clamp to exert a clamping force upon a head of a rivet to maintain the rivet in a selected opening of a workpiece;
heating an opposed end of the rivet in preparation for shaping;
deforming the opposed end of the rivet to a desired shape with a hammer.

2. The method as defined in claim 1, wherein the workpiece is an endless track of a tracked vehicle and the selected opening is provided by connectors between two adjoining sections of track.

3. The method as defined in claim 1, wherein the clamp has a body defining a channel which accommodates a portion of the workpiece and a rotatable pressure screw which, when rotated in a first rotational direction, moves in a first axial direction and when rotated in a second rotation direction moves in a second axial direction, means being provided to rotate the pressure screw to exert the clamping force upon the head of the rivet.

4. A method of hot riveting, comprising the steps of:
using a clamp to exert a clamping force upon a head of a rivet to maintain the rivet in a selected opening of an endless track of a tracked vehicle, the selected opening being provided by connectors between two adjoining sections of track;
the clamp having a body defining a channel to accommodate a portion of the endless track and a rotatable pressure screw which, when rotated in a first rotational direction, moves in a first axial direction and when rotated in a second rotation direction moves in a second axial direction, a wrench engaging screw head being provided by means of which the pressure screw is rotated to exert the clamping force upon the head of the rivet;
heating an opposed end of the rivet in preparation for shaping;
deforming the opposed end of the rivet to a desired shape with a hammer.

5. The method as defined in claim 4, wherein the body has hooks along a first side of the channel opposed to the pressure screw and pointing toward a second side of the channel, the hooks being adapted for insertion into adjoining sections of the endless track.

6. An apparatus for hot riveting, comprising:
a clamp having a body defining a channel to accommodate a portion of an endless track;
a rotatable pressure screw mounted on the body which, when rotated in a first rotational direction, moves in a first axial direction firer into the channel and when rotated in a second rotation direction moves in a second axial direction withdrawing from the channel;
a wrench engaging screw head on the pressure screw by means of which the pressure screw is rotated to exert the clamping force; and
hooks integrally formed with the body along a first side of the channel opposed to the pressure screw and pointing toward a second side of the channel, the hooks being adapted for insertion into sections of the endless track.
